(19) United States
(12) Patent Application Publication
(10) Pub. No.: US 2011/0161985 A1
(43) Pub. Date: Jun. 30, 2011

(54) METHOD FOR ACCESS TO A TRANSMISSION MEDIUM

(76) Inventors: Gerhard Karl Willi Witte, Langenfeld (DE); Wolfgang Martin Kallweit, Mettmann (DE)

(21) Appl. No.: 13/060,568

(22) PCT Filed: Oct. 28, 2009
(86) PCT No.: PCT/EP09/64189

§ 371 Date: Feb. 24, 2011

(30) Foreign Application Priority Data
Dec. 22, 2008 (EP) 08172615.0

(51) Int. Cl. G06F 9/46

(52) U.S. Cl. 719/313

(57) ABSTRACT

The invention relates to a method for preparing or effecting access, in data transmission, from a first application which is run on a client data processing device to a transmission medium which is coupled to the client data processing device. The steps performed are: providing a second application which includes at least one interface for converting the format of information, transmitted by the first application, to a standard format which is predetermined by the second application; and registering the second application with the client data processing device or installing the second application on the client data processing device in order to transmit the information of the first application in the standard format between the second application and the transmission medium or to enable the information of the first application to be transmitted in the standard format between the second application and the transmission medium.

The invention relates to a method, a computer program, a data storage unit and a system for preparing or effecting access, in particular data transmission, from an application to a transmission medium.

When running computer applications, for example programs for data processing or word processing, graphic programs or sector-specific process control programs, results can be ascertained or generated in the form of data which are for example provided as files or data streams. These data generally exhibit a format which is specific to the computer application in question. Exchanging data or communicating between different computer applications can be a complicated and laborious process due to the difference in the data formats associated with them. Exchanging data or simply sending data from a computer application using a transmission medium such as for example the internet, or to a server application connected to the transmission medium, can prove equally complicated.

It is an object of the invention to provide a method, with the aid of which access, in particular data transmission, by a computer application running on a data processing device to a transmission medium which is coupled to the data processing device can be simplified.

The above object is solved by the subjects of the independent claims. The dependent claims are directed to advantageous developments.

One aspect of the invention relates to a method for preparing or effecting access, in particular data transmission, from a first application which can be or is run on a client data processing device to a transmission medium which is coupled to the client data processing device. The transmission medium can be a computer network or communications network, for example a LAN, a WAN or preferably the internet. Preparing access can mean that measures are taken prior to access which solve the stated object. Effecting access can mean that data transmission between the first application and the transmission medium is performed by the method.

The method includes the steps of providing a second application and registering the second application with the client data processing device or installing the second application on the client data processing device. The second application comprises at least one interface for standardising data formats, i.e. for converting the format of information, transmitted by the first application, to a standard format which is predetermined by the second application. The information transmitted by the first application can for example exhibit a DOC, RTF, TXT, GIF, JPEG, HTML or other format. The standard format predetermined by the second application can be an XML, PDF/A or other standard format.

Registering the second application with the client data processing device or installing the second application on the client data processing device can serve to inform the client data processing device that the second application is ready to be run, and can serve to transmit configuration parameters or settings of the second application to the client data processing device. The configuration parameters of the second application can for example relate to the format of the information sent from the first application and/or the desired standard format and can be entered in a registry and/or in a configuration file of the first or second application and/or an operating system. The settings made can persist, i.e. they can be retained even after the second application has been repeatedly opened and closed and after the client data processing device has been switched off and on.

When running the second application on the client data processing device, registering or installing the second application can enable or cause the information of the first application to be transmitted in the standard format between the second application and the transmission medium. Enabling the transmission can also relate to a process which was started before the installation, wherein the information to be transmitted and/or a transmission process associated with it are in a queue (batch job). When run in such a delayed manner, the transmission process can run the second application and access the configuration parameters defined during installation.

In accordance with one embodiment, the information transmitted from the first application is initially converted into an intermediate format and then into the standard format. The intermediate format can for example be the cross-platform Portable Document Format (PDF). This two-stage conversion can be realised simply and efficiently, because a multitude of high-performance format converters for converting an arbitrary data format into the popular PDF format are known, for example PDFCreator, and because PDF is an old, well-known and developed format and PDF documents are therefore easy to parse in order to be converted into the standard format, for example into an XML format.

In accordance with another embodiment, the second application can provide a selection or input template for inputting information. The input template can be a graphic user interface, preferably a Windows application, or a platform-independent application, for example an application which is integrated in a web browser. The information can include text, control commands and/or stored files, wherein the files are uploaded, and added to the data to be transmitted, by means of a menu of the input template. Once the information has been entered in the input template, the information can be converted into the standard format and transmitted to the transmission medium.

In accordance with one embodiment, the second application can include a plurality of client interfaces for a plurality of first applications and at least one standard interface for at least one standard format. If an intermediate format converter is provided, the selection of the client interfaces is determined by the intermediate format converter, for example PDFCreator. If an intermediate format converter is not provided, the client interfaces can include all known or common file formats. The information in the format to be converted is transmitted between the first application and the second application via the client interface which is selected from the plurality of client interfaces and assigned to the first application, and between the second application and the transmission medium via the at least one standard interface assigned to the standard format. Once the client interface and/or standard interface has been designated, this designation can persist during a run time of the second application and/or during a run time of the operating system and/or up until it is re-designated.

In accordance with another embodiment, a communications device which is coupled to the standard interface of the second application and to the transmission medium and which includes for example a data sender and/or a data receiver can transmit the information in the standard format between the second application and the transmission medium. The communications device can be a web service client which can communicate via a computer network, in particular the internet, with a web service server and/or another web service client. This communication can be encrypted or non-encrypted, wherein an encryption includes the common or cryptographic methods, for example 128-bit SSL.

In accordance with one embodiment, the second application can be a driver, in particular a printer driver, for implementing unidirectional or bidirectional communication between the first application and the transmission medium and/or communications device. Implementing the second application as a driver has the distinct advantage of being very user-friendly and flexible, because almost all applications comprise a printer output and an associated menu for selecting a suitable printer driver. The second application can thus be inserted in a selection list of the first application comprising available printer drivers, which enables a data transmission via the second application to be simply and intuitively selected or designated. The second application is run by means of a print command to the printer driver, wherein the input template for inputting information is provided immediately after the second application has been opened. By integrating the second application as a printer driver into a first application, the client interface of the second application of the second application is directly or indirectly designated.

In accordance with another embodiment, a server application can receive—in the standard format—the information which has been sent from a first application, converted into the standard format by means of the second application and transmitted by the communications device. The server application, which is run on a server data processing device coupled to the transmission medium, is designed to receive, send and/or manage information in the standard format. Managing information can include maintaining a database, inserting the information into the database and/or compiling statistics with respect to the information.

In accordance with one embodiment, the information in the standard format transmitted by the communications device of the client data processing device to the server application can be translated by a parser of the server application into a format which is suitable for further processing, in order to be automatically further processed by the server application. Parsing enables access to individual items of information or groups of information, for example addresses, text comments and/or images. Automatic further processing can include a plausibility test, archiving and/or visually displaying the information on a display which is coupled to the server data processing device. The plausibility test relates to identifying incorrect or missing data in the information transmitted. A negative result of the plausibility test can be integrated in a feedback and sent to the client data processing device, or an alarm on the server data processing device is triggered.

In accordance with one embodiment, the second application which is installed on the client data processing device can comprise an automatic update function. The update function can preferably test, every time the second application is run, whether a version of the second application which is installed on the client data processing device is a current version of the second application. If the test result is positive, an update of the second application is not performed. If the test result is negative, the second application which is installed on the client data processing device is updated, i.e. an update is performed. The test can also be performed at regular or irregular time intervals, wherein the times of the test can as applicable be individually designated.

In accordance with another embodiment, the server application can send a confirmation of receipt to the communications device after it has received the information in the standard format transmitted by the communications device which is in operation on the client data processing device. The confirmation of receipt can include a result of the plausibility test on the information transmitted, including a request for information which is missing or incorrect in the data stream from the client to the server, and/or a schedule or plan for future actions.

Another aspect of the invention relates to a computer program which is configured to perform the method in accordance with the invention when it is loaded or run on a data processing device. Loading the computer program can mean that a version of the computer program which can be run is ready on a storage medium of the data processing device to be run or is already run by loading the computer program.

Another aspect of the invention relates to a data storage unit or computer program product which includes the computer program.

Another aspect of the invention relates to a system for preparing or effecting access, in particular data transmission, from a first application which can be or is run on a client data processing device to a transmission medium—for example a computer network, preferably the internet—which is coupled to the client data processing device. A second application is provided which comprises at least one interface for converting the format of information, transmitted by the first application, to a standard format which is predetermined by the second application. This second application can be registered with the client data processing device or installed on the client data processing device in order to transmit the information of the first application in the standard format between the second application and the transmission medium or to enable the information of the first application to be transmitted in the standard format between the second application and the transmission medium.

A computer program which is configured to implement the system for preparing or effecting access to the transmission medium can be stored on a portable storage medium, for example a USB stick. The program can be run by connecting the USB stick to a PC, which makes the system available to the applications installed on the PC.

The present invention shall be explained in more detail on the basis of example embodiments. There is shown:

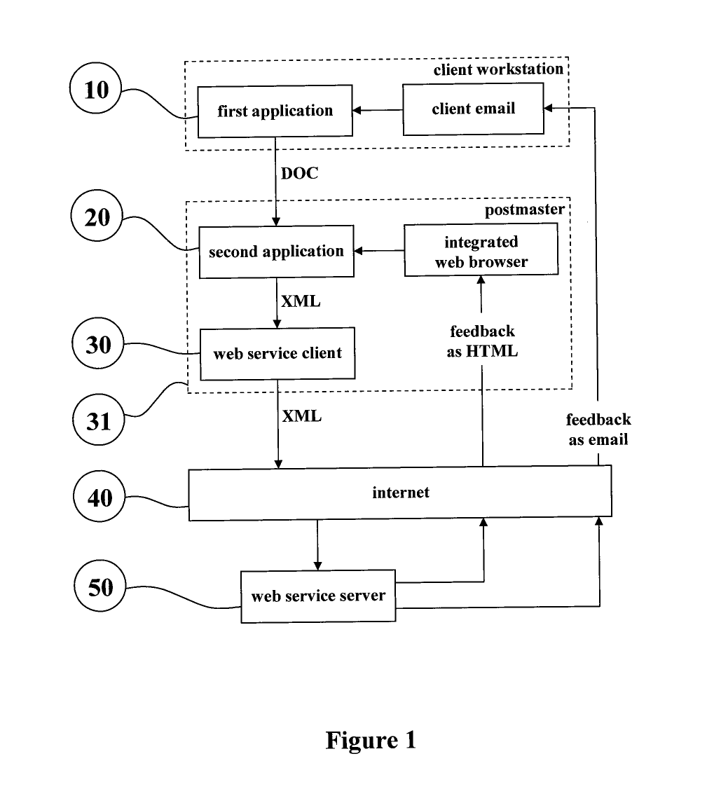

FIG. 1 a schematic representation of the functional elements for performing the method in accordance with the invention, in a first example embodiment;

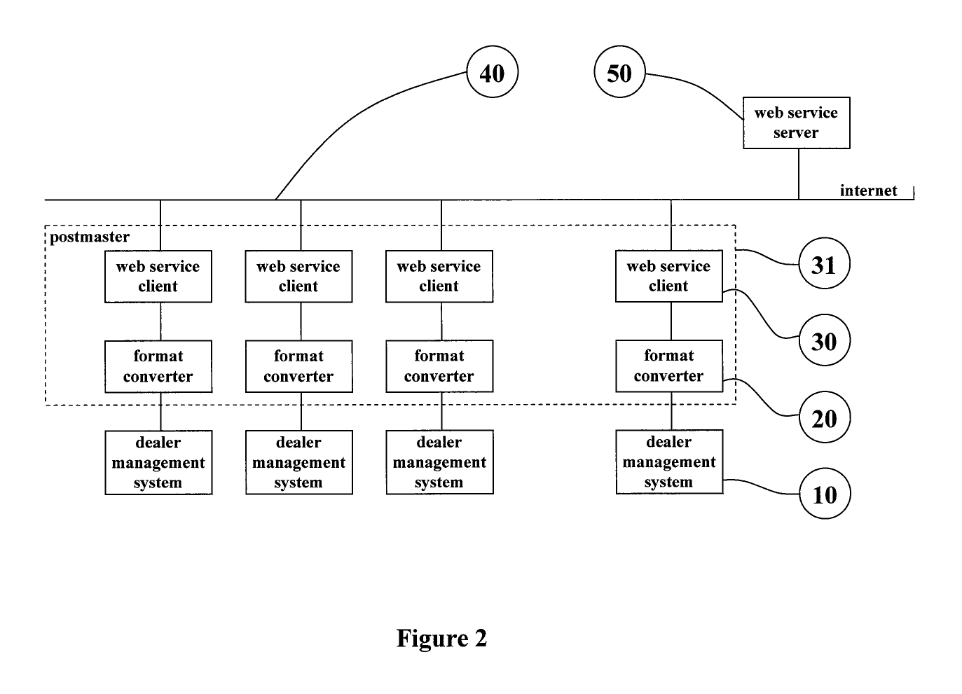

FIG. 2 a schematic representation of the functional elements for performing the method in accordance with the invention, in a second example embodiment;

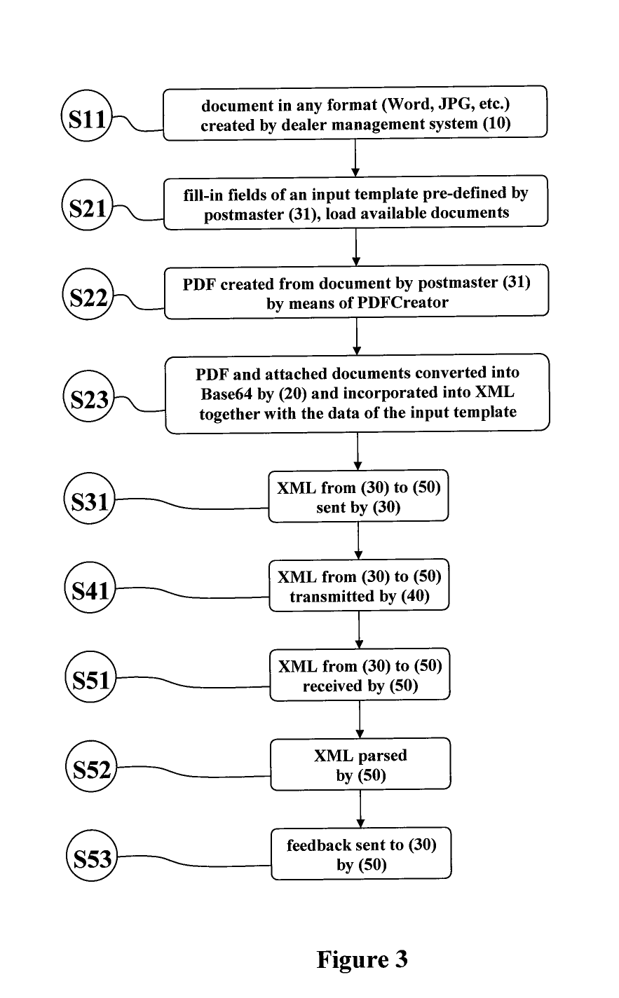

FIG. 3 a workflow of the method steps in accordance with the second example embodiment;

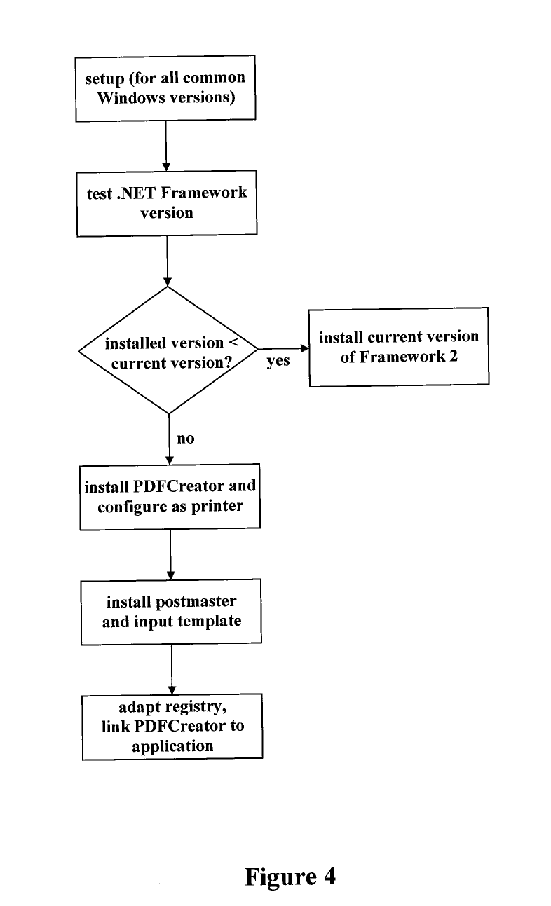

FIG. 4 a workflow of the method steps of installing the postmaster, in accordance with a third example embodiment; and

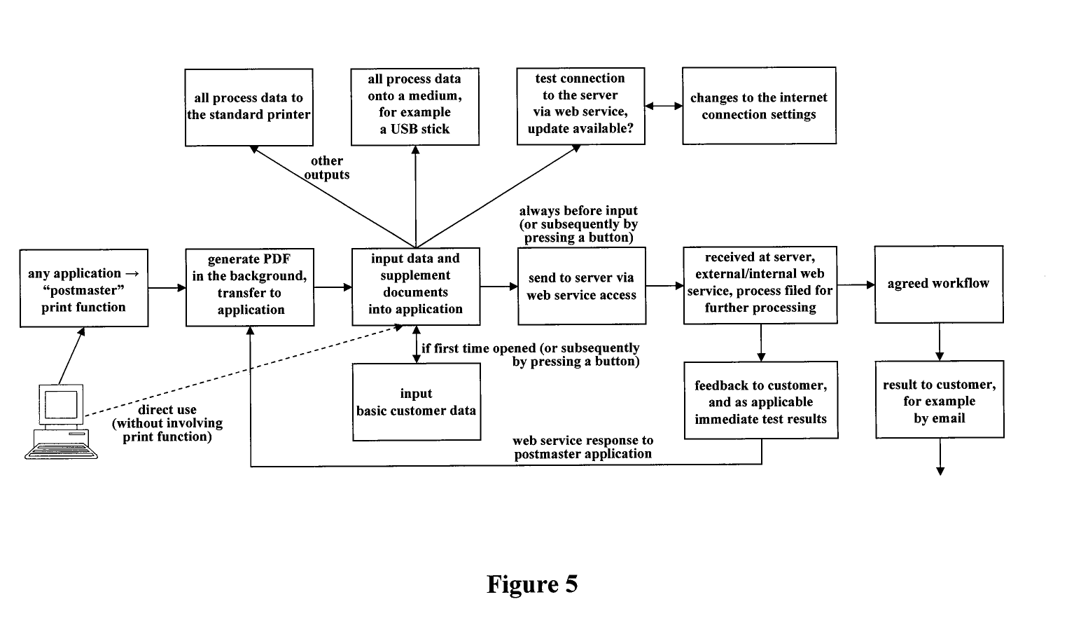

FIG. 5 a flow/operating diagram of the postmaster, in accordance with the third example embodiment.

FIG. 1 shows a schematic representation of the functional elements for performing the method in accordance with the invention. This first example embodiment relates to preparing or effecting data transmission by a first application 10 which can be or is run on a client data processing device—preferably, a text or graphics application—to the internet 40, which is coupled to the client data processing device.

A second application 20 which is coupled to the first application 10 for data transmission comprises at least one interface for converting the format of information, transmitted by the first application 10, to a standard format which is predetermined by the second application 20. In the present case, the standard format is an XML format. The second application 20 is coupled on its input side to the first application 10 and on its output side to a web service client 30. The web service client 30 is configured to transmit and receive information in XML format. A postmaster 31 represents a functional unit which includes the second application 20 and the web service client 30.

A web service server 50 is coupled to the internet 40 in order to receive and send information in HTML or XML format and to send and/or receive emails. The internet 40 represents a transmission medium for transmitting information between the web service client 30 and the web service server 50. The transmission medium can also be a storage device such as for example a USB stick, a CD-ROM or a hard disc. The web service server 50 is configured to receive messages in XML format from the web service client 30 and to then send a feedback to the first application 10 by email.

The web server receives a document in XML format from the client, but sends back a document in HTML format which is displayed, client-specifically and process-specifically, as the result in a web browser which is integrated in the postmaster 31. The integrated web browser displays a website as the result, including other links to test reports, documents, etc. which pertain to the respective client and to the process sent. The same thing also occurs in the event of an update of the postmaster 31: an integrated web browser window is opened, and the customer-specific update of the postmaster application is provided. Additionally, the web server can also send back responses or a summary of the input by email—this method is optional and is decoupled from the direct response to the postmaster via a return response by the web service on the web server.

The second application 20 is registered with the client data processing device or installed on the client data processing device in order to transmit the information of the first application 10 in the standard format between the second application 20 and the transmission medium 40 or to enable the information of the first application 10 to be transmitted in the standard format between the second application 20 and the transmission medium 40. The second application 20 is therefore ready to perform a conversion of information provided by the first application 10.

FIG. 2 shows a schematic representation of the functional elements for performing the method in accordance with the invention, in a second example embodiment. In this second example embodiment, the first application is a dealer management system 10 and the second application is a format converter 20 which substantially performs a two-stage format conversion from an arbitrary format of an input document to PDF by means of PDFCreator and then from PDF to XML.

The problem in networking car workshops, insurance companies, appraisal experts, other tradesmen, car rental agencies and car manufacturers is that numerous industry packages—so-called dealer management systems—are available, which all have their own interfaces. If one wishes to send structured data or simple documents from these applications, it is necessary to program a special interface in the respective software in order to then be able to transmit these data to a particular address. More than a thousand different dealer management systems are available in the car industry alone, with the result that networking is extremely difficult and/or that products from individual software packages can then in turn only be transmitted via particular communications nodes.

In order to then allow communication with blanket coverage as quickly and uniformly as possible, a postmaster is provided which can in principle be implemented as a printer driver into the respective operating system. This printer driver can then be selected as an alternative to available printers or can also be pre-selected as standard. This printer driver then allows a selection template which enables an operator to then make specific enquiries according to particular recipient data such as for example selecting the respective insurance company, and also according to data on the other party in an accident, such as for example the license-plate number, type of vehicle and so on. When the “send” key is then pressed, the respective file is automatically transmitted in the background if an internet connection is available. These files can be any files, such as Word files, PDF files or image files. Thus, practically any files and information can be transmitted which is/are also made available to the printer in all programs. These files also then reach us in a structured form, such that we can read the information out using suitable parsers and then digitally process it further.

This variant has the serious advantage that a way of selecting a printer is available in all the different dealer management systems, image processing systems and standard programs. The standard printer can then also be automatically pre-allocated via the postmaster printer driver, or the files can for example be securely stored on a USB stick or elsewhere. During the transmission, which proceeds in the background, a web service server registers whether the process has been received and immediately sends back a receipt, with the result that the sender can also be certain that their documents have reached the recipient. The receipt is an HTML document which is displayed in a web browser which is integrated in the postmaster 31. Other references (links) to documents relating to the process, such as for example test reports or the like, can be embedded therein.

FIG. 3 shows a workflow of the method steps in accordance with a second example embodiment. The method steps are explained in connection with the functional elements shown in FIGS. 1 and 2, wherein it is presupposed that the format converter 20 is registered with the client data processing device or installed on the client data processing device in order to transmit the information of the dealer management system 10 in the standard format between the dealer management system 10 and the internet 40 or to enable the information of the dealer management system 10 to be transmitted in the standard format between the dealer management system 10 and the internet 40.

A document, for example a text document or graphics document, is created by the dealer management system 10 in step S11. In order to send the document to an administrative centre which is coupled to a web service server 50 and/or in order to access the internet 40, the postmaster 31 is designated in the driver selection list of the dealer management system 10 by selecting a corresponding driver. Once this designation has been transmitted to the postmaster 31 accessed by the dealer management system 10, an input template or selection template of the postmaster 31 is provided in step S21, by means of which text to be transmitted can be inputted and files to be transmitted can be uploaded. The information to be transmitted is then converted into the intermediate format PDF by means of PDFCreator in step S22, and into the standard format XML in step S23. In the subsequent steps S31, S41 and S51, the information in XML format is sent from the web service client 30 to the web service server 50 via the internet 40. The information in XML format is received by the web service server 50, parsed S52, archived and as applicable evaluated statistically and/or by an operator. Lastly, the web service server 50 sends a feedback regarding the information received to the dealer management system 10 in step S53.

FIGS. 4 and 5 show a workflow of the method steps of installing the postmaster, and a flow/operating diagram of the postmaster, in connection with a third example embodiment.

The postmaster substantially consists of the following, mutually dependent parts.

1.) An automatic setup routine for all common Windows operating systems (Windows 2000, 2003, XP, etc., and now also Windows Vista).

2.) NET Framework 2 (prerequisite for the postmaster application, which was developed using .NET). The automatic setup function determines whether Microsoft Framework 2 or above is installed; if it is not, then it is additionally installed automatically (included in the packaged setup program).

3.) A virtual PDFCreator printer driver (a virtual printer which, after the “Windows print function” has been selected, generates a PDF of the document to be printed and forwards it to the postmaster template and/or client application in order for other data and documents to be supplemented). The setup installs the virtual and commercially freely usable PDFCreator printer driver (based on Ghostscript), wherein all the relevant values such as installation paths, printer names (“postmaster”), etc. are automatically set. It adapts the registry data for PDFCreator (for all users of the Windows system), in order that PDFCreator automatically stores its generated PDF documents and then accesses the postmaster template and/or client application and transfers the respective PDF file. The new printer is entered in the Windows printer list and is immediately available to all Windows applications comprising a print function.

4.) The actual postmaster template and/or client application on the client side (data transfer, supplementing and inputting by the customer, storing complete processes on any media such as for example USB sticks and, in addition to a send function, a complete print of all data).

If a print is initiated from any application via the “postmaster” entry available in the printer list, then the postmaster template and/or client application is opened and receives the generated PDF file from PDFCreator (this all occurs in the background—all that can be seen is that the template is opened together with the PDF which has been transferred for viewing). The generated PDF is normally “text-based”, i.e. it is possible to access text contents without text recognition (OCR)—images are retained as images in PDF, hence simple text-based standard tests are immediately possible (an automatic, accelerated process providing an immediate return response comprising the “test results”).

When the application is first opened, it waits for the “basic client data” to be inputted—data which enable things to be assigned to the client and also enable the collected process data to be automatically sent back to the client by email—for the purpose of storing them together and as an additional confirmation of receipt.

The program initially tests the connection to the web service server and also checks whether a new version of the client application (postmaster) is available and can be downloaded and/or whether it is nonetheless possible to send using the out-of-date application (a subsequent update, since the application is still compatible). The program enables numerous internet connection settings, such as for example a direct connection (for example for workshops using individual DSL connections), via a proxy or firewall (for example for customers using a central internet server with many users connected), etc., such that it can be used anywhere.

The program enables the generated PDF to be viewed and other structured (process) data to be inputted, and enables other documents, such as for example images and/or texts, to be added simply (highlighting them all and adding them in just “one click”).

If everything is complete, the program creates an XML file comprising all the collected data (all the documents and/or images being inserted in Base64 format into the XML document) which is sent to the web service server 50 via web service access using a normal (or “https-encrypted”) internet connection.

It is equally possible to store all the data collected in one process on any medium (for example, a hard disc or USB stick) and, in addition to directly sending them, to print them out completely using a connected printer.

The program immediately displays the result of the dispatch (a return response from the accessed web service); depending on the subsequent process, reports and automatically generated test results can also be directly sent back—there is thus absolute certainty that all the data have actually been received.

The client application can also be opened directly (not only via the print function). If, for example, “incomplete processes” (which have already been sent) are to be rounded off with other data and/or documents, then the latter can also be sent directly via the application, without involving a print function. It is possible to reference the “old, incomplete” process.

5.) A web service on an external web server (for centrally receiving the client data from the postmaster application and forwarding them to the internal web servers, to be actually processed and filed as a process).

The external web service receives the XML file comprising all the data from the client application and forwards it to our internal web server and/or web service (“dissemination for reasons of security”), to be actually filed as a process and for a confirmation response.

6.) A web service server, distributed over a plurality of redundant (fail-safe) internal web servers (for receiving the client data and filing the basic process together with all the documents and structured data, and for automatic version control and an update function for the postmaster client application at the customer or user end).

The internal web service server evaluates the XML file received, extracts all the data and documents, sends a return response to the “customer” (back via the external web service and then directly to the client application) and files a process which is dealt with in the “normal” flow of work.

The version of the client application is also tested at this point, such that an automatic update can be performed or an indication to this effect can be given to the user.

As a result, the focus of the postmaster application is on the data transmission to the web service server 50 via the internet 40 (secured or alternatively non-secured), and only secondarily on storing on a memory stick or data storage medium (for example, at the client end).

FIG. 3 shows that other documents, any images, etc. can also be transmitted as well and loaded into the input template. Simply supplementing the process (the PDF and the input data) with any documents which are already stored and independent of printing is an important function. All the documents and inputs are collected in an XML document. The transmission back (the response) can be regarded as a summary of two independent threads: the direct response by the web service and the direct display of a result; and an additionally possible response via email. Other (subsequent) return responses via other channels are of course also possible, such as for example “rerouting” processes to other systems, for example the network of the GDV (Gesamtverband der Versicherungswirtschaft=German Insurance Federation).

The direct response by the web service to the postmaster client application is a website which can be dynamically generated, including links and a store of for example test reports or the like.

The postmaster can be automatically updated, for example via a website which is dynamically generated by the postmaster as a response and comprises all the information for this purpose, as applicable in accordance with a “client ID” (i.e. the update is “client-specific”).

It is optionally possible to switch to non-encrypted or 128-bit encrypted SSL data transmission—given the latter setting, all contents, inputs and/or documents are correspondingly encrypted. The setting is automatically made available for all transmissions once it is installed (as is also the case with all other settings). The filing of a process is also then redundantly integrated, i.e. if one server fails, a diversion is made to another server and an attempt made to file the process via said other server. Normally, a web service on the external web server receives the process and forwards it to an internal web service (only then is access for storing the data in the archive possible), where the actual filing of the process occurs. If an internal web server/service then fails, another internal server is contacted and said other server attempts to file the process using an equivalently installed web service.

The final redundant web server/service in the list of all the redundant web servers is located on the external web server itself (i.e. not, as is usual, purely internally). In the event of a power cut (if the external web server also fails), the postmaster then stores all the data on the external web server. The data can then be retrieved at any time from internally, once the power is back on (or in general terms, once the internal servers are available again).

If processes have been provided on the external web server for retrieval, this is indicated by a configured directory monitor—as soon as everything is running again internally and emails can be received, an email is continuously received which indicates these processes which are “outside” and ready to be transferred.

### LIST OF REFERENCE SIGNS

10 first application
20 second application
30 communications device, web service client
31 postmaster
40 transmission medium, internet
50 server application, web service server

1. A method for preparing or effecting access, in particular data transmission, from a first application which is run on a client data processing device to a transmission medium which is coupled to the client data processing device, said method comprising the steps of:
providing a second application which comprises at least one interface for converting a format of information, transmitted by the first application, to a standard format which is predetermined by the second application; and
registering said second application with the client data processing device or installing said second application on the client data processing device in order to transmit the information of the first application in the standard format between the second application and the transmission medium or to enable the information of the first application to be transmitted in the standard format between the second application and the transmission medium.

2. The method according to claim 1, wherein the following steps for converting the format are performed:
converting the format of information, transmitted by the first application, into an intermediate format; and
converting the information obtained in the preceding step from the intermediate format into the standard format.

3. The method according to claim 1, wherein the second application provides a selection template for inputting information, in particular into pre-defined input fields, which once inputted is converted into the standard format and transmitted to the transmission medium.

4. The method according to claim 1, wherein the second application includes a plurality of client interfaces for a plurality of first applications and at least one standard interface for at least one standard format, wherein information is transmitted between the first application and the second application via the client interface which is assigned to the first application, and between the second application and the transmission medium via the at least one standard interface assigned to the standard format.

5. The method according to claim 4, wherein a communications device which is coupled to the standard interface of the second application and to the transmission medium and which includes for example a data sender and/or a data receiver transmits the information in the standard format between the second application and the transmission medium.

6. The method according to claim 1, wherein the second application is a driver for implementing unidirectional or bidirectional communication between the first application and at least one of the transmission medium or a communications device.

7. The method according to claim 1, wherein a server application which is designed to receive or manage information in the standard format and is located on a server data processing device which is coupled to the transmission medium receives—in the standard format—the information which has been sent from the first application, converted into the standard format by means of the second application and transmitted by a communications device.

8. The method according to claim 7, wherein the information in the standard format transmitted by the communications device to the server application is translated by a parser of the server application into a format which is predetermined or suitable for further processing, in order to be automatically further processed by the server application.

9. The method according to claim 1, wherein the second application which is installed on the client data processing device tests, at designated times, whether a version of the second application which is installed on the client data processing device is a current version of the second application, and wherein, if this is not the case, the second application which is installed on the client data processing device is updated.

10. The method according to claim 1, wherein the server application sends a confirmation of receipt to a communications device after the server application has received the information in the standard format transmitted by the communications device which is in operation on the client data processing device.

11. (canceled)

12. A non-transitory data storage unit or computer program product which is configured to perform the method according to claim 1 when it is loaded or run on a data processing device.

13. A system for preparing or effecting access, in particular data transmission, from a first application which run on a client data processing device to a transmission medium which is coupled to the client data processing device, wherein:
a second application is provided or predetermined which comprises at least one interface for converting the format of information, transmitted by the first application, into a standard format which is predetermined by the second application; and
this second application is configured to be registered with the client data processing device or installed on the client data processing device in order to transmit the information of the first application in the standard format between the second application and the transmission medium or to enable the information of the first application to be transmitted in the standard format between the second application and the transmission medium.
